(19) United States
(12) Patent Application Publication
(10) Pub. No.: US 2005/0190370 A1
(43) Pub. Date: Sep. 1, 2005

(54) Turbidity sensing system with reduced temperature effects

(75) Inventors: Calin Ciobanu, Brea, CA (US); Behzad Rezvani, Anaheim, CA (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Rosemount Analytical Inc., Irvine, CA (US)

(21) Appl. No.: 11/064,178

(22) Filed: Feb. 23, 2005

Related U.S. Application Data
(60) Provisional application No. 60/548,084, filed on Feb. 26, 2004.

(51) Int. Cl. G01N 21/00

(52) U.S. Cl. 356/442

(57) ABSTRACT

A turbidity measurement system with an improved thermal behavior is provided. A turbidity measurement system includes an analyzer and one or more turbidity sensors. Each turbidity sensor includes a source of illumination and a semiconductor-based illumination sensor. The dark current of the semiconductor-based illumination sensor is measured when no illumination is provided by the source. This measured dark current is then used to provide a dark current-compensated turbidity measurement.

### CROSS-REFERENCE TO CO-PENDING APPLICATION

The present application is based on and claims the benefit of U.S. provisional patent application Ser. No. 60/548,084, filed Feb. 26, 2004, the content of which is hereby incorporated by reference in its entirety.

### BACKGROUND OF THE INVENTION

The present invention relates to turbidity sensors. More particularly, the present invention relates to turbidity sensors and the effect of temperature on such sensors.

Turbidity sensors essentially measure the “cloudiness” of a fluid such as water. This measurement is generally done by directing one or more beams of light, either visible or invisible, into the fluid and detecting the degree to which light is scattered off of solid particles suspended in the fluid solution. The resulting turbidity measurement is generally given in Nephelometric Turbidity Units (NTU).

Turbidity measurement systems are used in a wide array of applications including water and waste water monitoring, food and beverage processing, filtration processes, biological sludge control, water quality measurement and management, final effluent monitoring, and even devices such as dishwashers and washing machines.

One of the difficulties with turbidity measurement systems arises from the nature of such systems. Specifically, turbidity measurement systems almost invariably employ optical techniques to arrive at a turbidity measurement. Thus, some form of illumination is required to generate or otherwise direct light into the fluid sample, and some form of detector is required to detect the amount of light scattered by the solid particles suspended in the fluid. For a number of applications, temperature compensation of the turbidity measurement is required. In such applications, if temperature compensation were not provided, temperature fluctuations would be interpreted as fluctuations in the turbidity value and would lead to erroneous results in the evaluation of the turbidity signal.

One type of temperature effect known to affect turbidity sensors is due primarily to the temperature of a phototransistor used to detect the light. Phototransistors generally have a property that provides some finite current even when the phototransistor is not exposed to any light whatsoever. This current is called “dark current” and is known to be influenced significantly by the temperature of the photosensitive element. The photosensitive element exhibits a strong dark current dependency to its temperature, while its span measurement is generally an order of magnitude less temperature dependent.

While attempts have been made to address the temperature effects on turbidity measurement systems, such attempts have generally employed additional temperature measurement devices, and/or complex algorithms to generate a temperature-compensated output. The more elaborate the apparatus and accompanying techniques used to provide temperature-compensation, the more costly the turbidity measurement system becomes. Furthermore, such approaches will generally fail if the temperature sensor itself begins to deteriorate, or otherwise become inaccurate.

Thus, there is a significant need for temperature-compensation in turbidity measurement systems that is simple, robust, and does not add significantly to the cost of turbidity measurement systems.

### SUMMARY OF THE INVENTION

A turbidity measurement system with an improved thermal behavior is provided. A turbidity measurement system includes an analyzer and one or more turbidity sensors. Each turbidity sensor includes a source of illumination and a semiconductor-based illumination sensor. The dark current of the semiconductor-based illumination sensor is measured when no illumination is provided by the source. This measured dark current is then used to provide a dark current-compensated turbidity measurement.

### BRIEF DESCRIPTION OF THE DRAWINGS

FIG. 1 is a diagrammatic view of a turbidity sensing system with which embodiments of the present invention are particularly useful.

FIG. 2 is a diagrammatic view of an analyzer coupled to a turbidity sensor.

FIG. 3 is a hypothetical current-time chart illustrating a dark current value of a photodetector.

FIG. 4 is a flow diagram of a method for providing dark current-compensated turbidity measurements in accordance with embodiments of the present invention.

### DETAILED DESCRIPTION OF THE PREFERRED EMBODIMENTS

While embodiments of the present invention will be described with respect to removing “dark current” related to temperature from turbidity measurements, embodiments of the present invention are practicable with any photosensitive element having a variable dark current, which variability is undesired in photosensing.

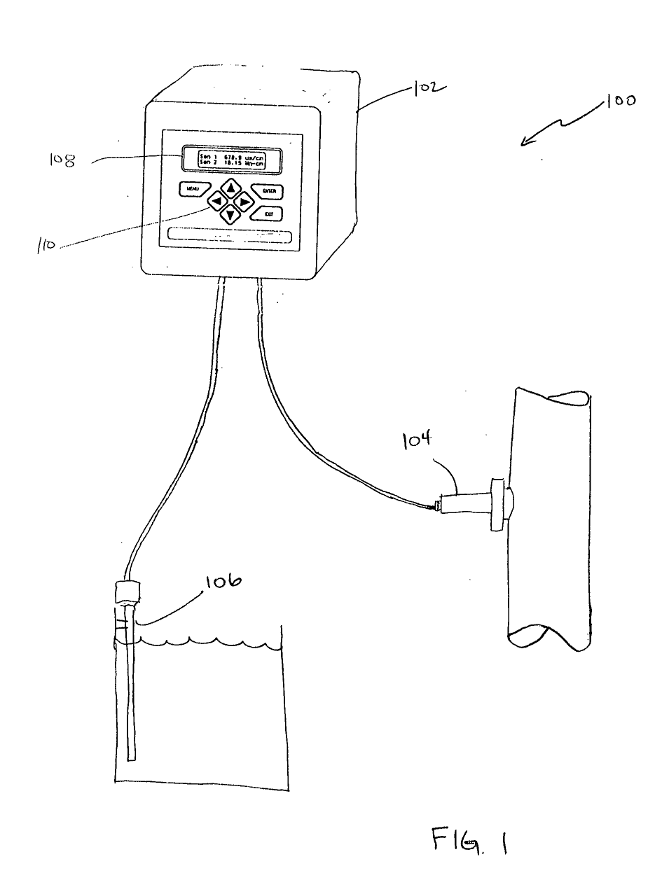

FIG. 1 is a diagrammatic view of turbidity sensing system 100 with which embodiments of the present invention are particularly useful. System 100 includes a turbidity analyzer or meter 102 coupled to one or more turbidity sensors 104, 106. Turbidity sensors may be any suitable types of turbidity sensors including an insertion-type turbidity sensor 104, and/or a submersion-type sensor 106. Further, any type of electromagnetic radiation may be used as illumination for the turbidity sensors. For example, sensors in compliance with U.S. EPA regulation 180.1 that use visible light can be used. Additionally, sensors in accordance with ISO 7027, which use near infrared LEDs may also be employed.

Analyzer 102 preferably includes an output 108 in the form of a display. Additionally, or alternatively, analyzer 102 may have a communication output providing the turbidity readings to an external device. Analyzer 102 also preferably includes a user input in the form of one or more buttons 110. However any suitable input can be used. In fact, analyzer 102 may receive input via a communication interface.

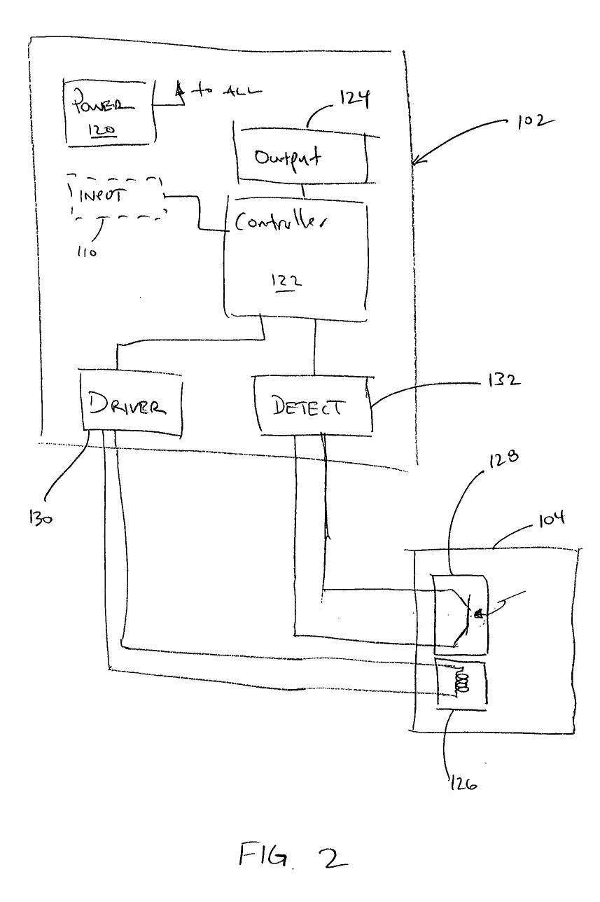

FIG. 2 is a diagrammatic view of analyzer 102 coupled to sensor 104. Analyzer 102 includes suitable power circuitry 120 to couple to a source of operating power, such as 85-265 volts AC, and provide a regulated output to all components within analyzer 102. Controller 122 receives its power from power module 120, and preferably includes a microprocessor. Controller 122 preferably includes or is coupled to suitable memory, such as Random Access Memory (RAM), Read Only Memory (ROM) and/or other suitable types of memory (not shown). Controller 122 is coupled to output module 124 that can take the form of a user interface output 108, a communications output, such as a 4-20 milliamp output, or any other suitable type of output, such as a wireless communication interface. An optional user input 110 is illustrated in phantom being coupled to controller 122.

Sensor 104 includes a source 126 of electromagnetic radiation. Preferably, electromagnetic radiation from source 126 is visible or near infrared illumination. Source 126 can take the form of an incandescent light, a strobe light, a light emitting diode, a laser diode, or any other suitable device. Sensor 104 also includes photodetector 128 that is illustrated as a phototransistor. However, photodetector 128 can be any semiconductor-based photosensitive device including a photodiode, a phototransistor, or a charge coupled device (CCD). Since photodetector 128 is a semiconductor-based device, it will have a temperature-sensitive dark current. Thus, a small amount of current flowing through photodetector 128 is due to the temperature of detector 128 and not any illumination falling thereon.

Analyzer 102 is coupled to turbidity sensor 104 via driver module 130 and detect module 132. Driver module 130 includes suitable power and/or switching circuitry to energize source 126 at a suitable level when desired by controller 122. Detect module 132 can be any suitable circuitry able to measure an electrical characteristic of photodetector 128 and provide an indication thereof to controller 122. For example, detect module 132 can include a known analog-to-digital converter converting the current or voltage flowing through detector 128, which current or voltage is primarily affected by illumination, and provide a digital indication thereof to controller 122. However, any other electrical arrangement may be used as desired.

In the past, the dark current of a photosensitive element in a turbidity sensing system was merely lumped in with a number of other temperature-sensitive features or elements of the system. Since the nature and degree of each element's temperature effects on the overall turbidity measurement system could vary, it was generally necessary to calibrate a turbidity measurement system by providing a known turbidity sample and obtaining measurements at a variety of different temperatures. Then, during operation, a temperature sensor would provide an indication of the actual temperature of the turbidity sensor and the stored calibration data could be used to provide a calibrated output based upon the actual measured temperature. This approach relied extensively on temperature sensors, and required each such system to be calibrated for temperature.

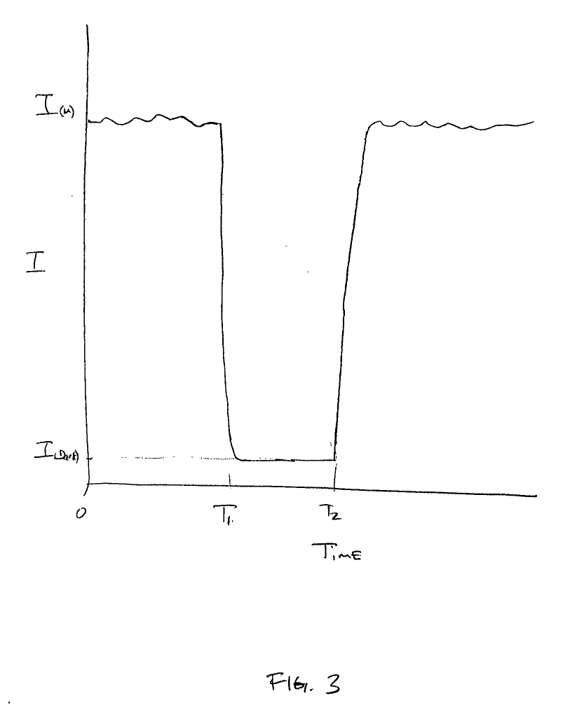

In accordance with embodiments of the present invention, it has been determined that at least one temperature sensitive effect of a turbidity system can be eliminated without calibration and without the use of a temperature sensor. Specifically, the dark current of a semiconductor-based photosensitive element can be eliminated by measuring the current when the detector is not exposed to any illumination. FIG. 3 illustrates a diagrammatic example of a hypothetical current-time chart illustrating this feature. Specifically, a photodetector output, such as the output of detector 128 registers a current I_{M} while exposed to the illumination of a turbidity measurement. Then, at a preselected time (T₁) the illumination is prevented from reaching detector 128. In response, the output of detector 128 quickly drops to its dark current value I_{dark}. At time T₂, illumination is again allowed to reach detector 128 and the detector output quickly returns to its original approximate I_{M} value. Then, a compensated output can be provided by simply subtracting I_{dark} from I_{M}. Such compensation can be performed mathematically or electronically using circuitry disposed in the analyzer, the sensor or both. The compensation can be as simple as subtraction, but may also involve computations of higher complexity. The manner in which the illumination can be prevented from reaching detector 128 can take different forms. For example, source 126 can simply be turned off. Alternately, a mechanical shutter, or any other suitable device, can physically interrupt the light path from source 126 to detector 128. Further, in some embodiments where detector 128 is only sensitive to illumination of a certain polarization, the polarization of light from source 126 can simply be changed.

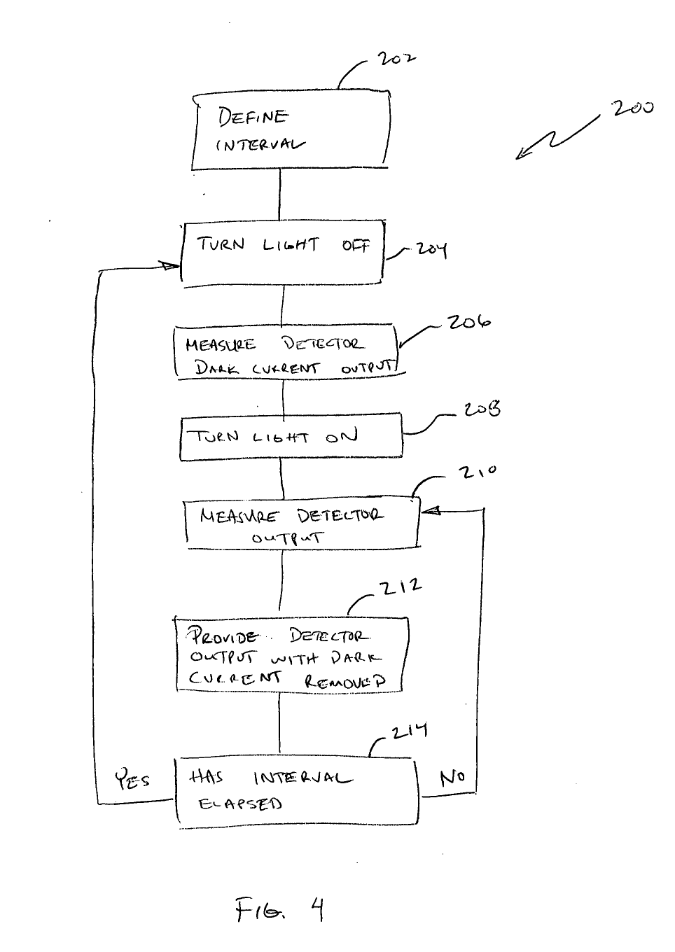

FIG. 4 is a flow diagram of a method for providing dark current compensated turbidity measurements in accordance with embodiments of the present invention. Method 200 begins at step 202 where an arbitrary interval is defined relative to the frequency with which dark current measurements should be performed. Thus, if the turbidity measurement application has temperatures that change relatively quickly, the interval may be relatively short or possibly as frequent as between each and every turbidity measurement. The interval may be defined in terms of elapsed time, number of turbidity measurement cycles, or any other suitable approach. At block 204, illumination is prevented from reaching the detector in the turbidity sensor. As set forth above, this can be accomplished by de-energizing a source of illumination, and/or alternatively obstructing illumination to the detector. At block 206, detect module 132 is used to obtain a parameter related to the dark current. In one embodiment, this is simple measuring the detector dark current output (I_{dark current}) while the light is turned off, or otherwise obstructed from reaching the detector. This dark current value is then saved, either in digital form, or maintained in electrical form such as stored as a charge on a capacitor, for later use. At block 208, source 126 is turned on and any interruption of the light path between source 126 and detector 128 is removed. At block 210 the detector output is measured using detect module 132 to obtain an uncompensated turbidity measurement. At block 212, a dark current-compensated turbidity measurement is provided. This quantity can be calculated in embodiments where both the dark current and uncompensated turbidity measurement are obtained using an analog-to-digital converter. Additionally, embodiments of the present invention also include electrical arrangements wherein the dark current quantity is subtracted electrically from the uncompensated turbidity measurement electrically. For example, when the dark current is stored as a quantity of charge on a capacitor, that quantity can be used to offset, or otherwise diminish, the uncompensated turbidity measurement. Further still, combinations of the above-described analog and digital approaches may be used in accordance with embodiments of the present invention. At block 214, it is determined whether the interval defined at block 202 has elapsed. For example, if the interval specifies that dark current measurements occur after each and every turbidity measurement, then block 214 will always branch to block 204. However, if the interval specified in block 202 requires that dark current be measured after every other turbidity measurement, then block 214 will alternate between branching to block 204 and block 210. In embodiments where the interval is specified in time, block 214 will return to block 204 only after the appropriate time interval has elapsed. Thus, embodiments of the present invention can respond to temperature changes at a selectable and relatively quick rate. Further, the temperature compensation provided by embodiments of the present invention is not reliant upon the use of a temperature sensor nor are they tied to an elaborate calibration.

Although the present invention has been described with reference to preferred embodiments, workers skilled in the art will recognize that changes may be made in form and detail without departing from the spirit and scope of the invention.

1. A turbidity measurement system comprising:
an analyzer;
at least one turbidity sensor coupled to the analyzer and having a source of illumination and a semiconductor-based photodetector having a variable dark current; and
circuitry configured to obtain a parameter related to dark current and to reduce error in turbidity measurements due to the dark current.

2. The system of claim 1, wherein the parameter related to dark current is converted to a digital value that is subtracted from a digital turbidity measurement.

3. The system of claim 1, wherein the parameter related to dark current is measured when the source of illumination is turned off.

4. The system of claim 1, wherein the parameter related to dark current is measured when illumination is prevented from reaching the photodetector.

5. The system of claim 1, wherein the photodetector is a phototransistor.

6. The system of claim 1, wherein the photodetector is a photodiode.

7. The system of claim 1, wherein the photodetector is a charge coupled device.

8. The system of claim 1, wherein the analyzer subtracts the dark current from the turbidity measurement.

9. The system of claim 1, wherein the source is a source of visible light.

10. The system of claim 1, wherein the source is a source is near infrared.

11. The system of claim 1, wherein the turbidity sensor is an insertion-type turbidity sensor.

12. The system of claim 1, wherein the turbidity sensor is a submersion-type turbidity sensor.

13. A method of providing turbidity measurements using an illumination source and a semiconductor-based photodetector, the method comprising:
obtaining a parameter related to a dark current of the photodetector;
generating illumination with the illumination source and directing the illumination at a turbidity sample;
obtaining an uncompensated turbidity measurement from the photodetector; and
compensating the uncompensated turbidity measurement as a function of the parameter related to dark current to generate a compensated turbidity output.

14. The method of claim 13, wherein measuring the dark current of the photodetector includes turning the source off and measuring current through the photodetector while the source is off.

15. The method of claim 13, wherein measuring the dark current of the photodetector includes measuring current through the photodetector while illumination from the source is prevented from reaching the photodetector.

16. The method of claim 13, wherein subtracting the dark current from the uncompensated turbidity measurement is performed digitally.

17. The method of claim 13, wherein subtracting the dark current from the uncompensated turbidity measurement is performed in analog circuitry.

18. A turbidity measurement system comprising:
an analyzer;
at least one turbidity sensor coupled to the analyzer and having a source of illumination and a semiconductor-based photodetector having a temperature sensitive dark current; and
means for compensating a turbidity measurement as a function of the dark current.
